(19) United States
(12) Patent Application Publication
(10) Pub. No.: US 2008/0261654 A1
(43) Pub. Date: Oct. 23, 2008

(54) INFORMATION PROCESSING SYSTEM

(76) Inventor: Anwar Abdullah Sakeen, Surra (KW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/736,656

(22) Filed: Apr. 18, 2007

(51) Int. Cl. H04B 1/38

(52) U.S. Cl. 455/558

(57) ABSTRACT

An information processing system for wireless access to an external subscriber and high speed searching of the internet incorporates a wireless modem that uses a Subscriber Identity Module (SIM) card and the technology of a third Generation System for Mobile Modems (iw3gsm) to connect a computer to the internet. A service provider provides access to the internet using a third Generation Global System (GGS) including General Packet Radio Services (GPRS) and/or Enhanced Data for Global Evaluation (EDGE) software.

### FIELD OF THE INVENTION

This invention relates to an information processing system and method and more particularly to a wireless system using a Subscriber Identity Module (SIM) Card and the technology of a third generation Global System for Mobile Communication (3GSM).

### BACKGROUND FOR THE INVENTION

In some regions of the world, a mobile communication terminal such as a cell phone is not limited to a single network service provider. Instead, subscribers to a network are issued a Smart Card i.e. a Subscriber Identification Module (SIM) Card that uniquely identifies a user account to the network, handles authentication and provides data storage for the user. The SIM or so called “Smart Card” may also provide user data such as phone numbers and network information. The Smart Card may also contain applications that can be accessed and the subscriber is free to use any phone that accepts a SIM Card or the like.

In use, SIM Cards often operate in conjunction with a wireless network environment such as the Global System for Mobile Communications (GSM) networks. With such networks, any phone that accepts a SIM Card can be used by inserting a SIM Card into the phone and accessing the network. Inserting a SIM Card into a GSM phone provides not only access to the network, but also provides access to private content stored in the internal memory of the phone. Thus, if the owner loses the phone, anyone with a SIM Card can access the owner's private content on the phone.

A U.S. Patent Application Publication of Liu, No. 2005/0164738 discloses a system and method to protect against unauthorized access to private content on a mobile terminal in a GSM environment. As disclosed therein, the private content is associated with the International Mobile Subscriber Identity (IMSI)/Mobile Station Integrated Series Digital Network (MSISDN) number of the content owner. The terminal correlates the IMSI/MSISDN information of the SIM with the IMSI/MSISDN information of the private content to grant access to the content only upon a positive content/SIM correlation.

It is now believed that there may be a demand for an information processing system wherein an internet wireless third generation system for mobile modem (iw3gsm) is combined with a SIM Card for access to the internet. Such systems will enable users to communicate with their office, email, file sharing etc. Such systems would be offered by cellular phone companies using the technology of the third generation of the Global System for Mobile Communications (GSMC), General Packet Radio Services (GPRS) and Enhanced Data for Global Evaluation (EDGE) networks.

Such systems allow downloading speeds approaching two Mps while using a dialup Asymmetric Digital Subscriber Line (ADSL) or broadband connection.

### BRIEF SUMMARY OF THE INVENTION

In essence the present invention contemplates an information processing system for providing a user with wireless access to an external service provider. The system incorporates a wireless modem that uses a Subscriber Identity Module (SIM) card and the technology of a third generation system for mobile modem (Iw3gsm) to connect a computer to the internet. The system in accordance with the present invention includes a transceiver and is capable of communication with an access point of a Wireless Area Network (WLAN).

A cellular phone company or the like provides the service access to the internet using third generation global systems for mobile communications technology including a General Packet Radio Services (GPRS) and/or Enhanced Data for Global Evaluation (EDGE). The phone company or the like also provides the user with a Subscriber Identification Module (SIM) Card that provides access to the cellular service provider or the like. The Subscriber Identification Module (SIM) Card is configured with a card for access to the Third Generation Global System for Mobile Communications, a user ID and a password and includes a network activation module. The system also includes a computer readable memory and a processor that is capable of executing instructions of a computer program stored in the computer readable memory.

The invention will now be described in connection with the accompanying drawings.

### DESCRIPTION OF THE DRAWINGS

FIG. 1 is a block diagram illustrating a preferred embodiment of the present invention;

FIG. 2 is a schematic illustration showing the operation of an Information Processing System in accordance with the present invention; and

FIG. 3 is a schematic illustration of a wireless modem using Iw3gsm by a cellular SIM Card.

### DESCRIPTION OF THE PREFERRED EMBODIMENTS OF THE INVENTION

Global Systems for Mobile Communications (GSM) are known. To be more specific, GSM is an open, non-proprietary system that is constantly evolving. One of its strengths results in its international roaming capability. This provides customers seamless and secure standardized same number contactable in more than 170 countries. In some cases GSM satellite roaming has extended service access to areas where territorial coverage is not available.

3GSM is the generic term used for the next generation of mobile communication services. These new systems will provide enhanced services to those available today, as for example voice, text and data. The concepts for 3GSM services are currently being developed across the industry and by global groups such as the Third Generation Partnership Project (3GPP). The GSM Associations vision of 3GSM is based on today's standard but evolved to include an additional radio air interface that is better suited to high speed and multi-media data service. Further, GSM has been designed with stringent levels of built-in security. And, with constantly enhanced transmission protocols and algorithms added to the flexibility and future proof platforms is the most secure public wire standard in the world.

GPRS (General Packet Radio Service) is considered to be the most wide spread wireless data service and is available with most GSM networks. GPRS represents a connectivity solution based on internet protocols that support a wide range of enterprise and consumer applications. With through put rates of up to 40 KBIT/s, users have a similar access speed to a dial-up modem, but with the convenience of being able to connect from anywhere.

EDGE (Enhanced Data Rate Evaluations) platforms are added to the GPRS services EDGE provides up to three times the data capacity of the GPRS. Therefore, operators using EDGE can handle three times more subscribers than GPRS, triple their data rate per subscriber, or add extra capacity. EDGE uses the same TDMA (Time Division Multiple Access) frame structure, logic channel and 200 KHz bandwidth as today's GSM networks. This allows it to be overlaid directly onto an existing GSM network. Also, for many existing GSM/GPRS networks EDGE is a simple software-upgrade. Further EDGE allows the delivery of advanced mobile services such as the downloading of video and music chips, full multi-media messaging, high-speed color internet access and email on the move.

A Subscriber Identity Module (SIM) card has a microchip with an internal memory that stores data, including but not limited to International Mobile Subscriber Identity (IMSI) information that provides the unique identity of a subscriber. The card may also provide access to the internet and allows the storage of names, numbers and Short Memory Services (SMS) messages.

The present invention is directed to an information processing system that includes a communication network for enabling information processing devices to communicate with private and public networks via an access point of a Wireless Local Area Network (WLAN).

For example, Wi-Fi is a brand originally licensed by the Wi-Fi Alliance to describe the underlying technology of wireless local area networks (WLAN) based on the IEEE 802.11 specification.

Wi-Fi was introduced to be used for mobile computing devices, such as laptops, in LANs, but is often used increasingly for other applications including internet and VoIP phone access and basic connectivity of consumer electronics such as televeisions and DVD players. A person with a Wi-Fi device, such as a computer can connect to the internet when in proximity of an access point. The region covered by one or several access points is called a hotspot. Hotspots can range from a single room to many square miles of overlapping hotspots. Wi-Fi can also be used to create a wireless mesh network. Both architectures are used in Wireless community network, municipal wireless networks like Wireless Philadelphia etc.

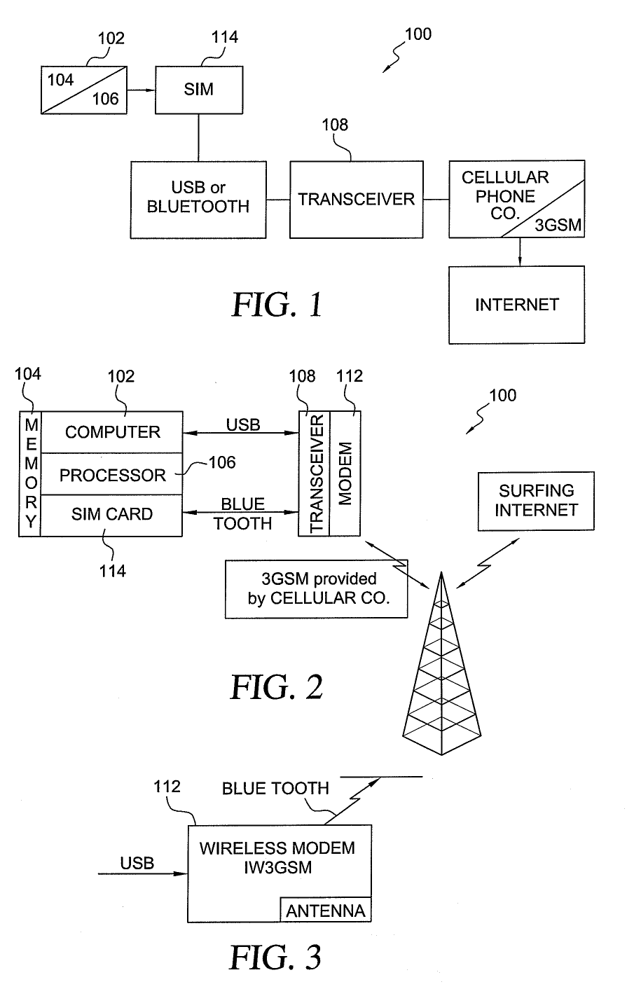

As illustrated in FIGS. 1-3, an information processing system 100 for providing a user with wireless access to an external service provider includes a computer 102 with a computer readable memory 104 and a processor 106 that is capable of executing instructions from a computer program stored in the computer readable memory. The system 100 also includes a transceiver 108 for connecting the computer to an access point of a Wireless Area Network (WAN).

An Internal Wireless Third Generation for global mobile modem (IW3GSM) 112 is provided for connection to the internet using Third Generation Global Systems for mobile communications (3GSM), General Packet Radio Services (GPRS) and/or Enhanced Data for Global Evaluations (EDGE). A Subscription Identification Module (SIM) card 114 that fits inside a phone based on GSM technology includes a network activation module is also provided.

In a preferred embodiment of the invention, the system 100 includes a virtual identity module, including subscriber identification and security information stored in the SIM Card 114 to enable the information processor to communicate with a public or private cellular network. For example, the information processor 106 is coupled to a Subscriber Identity Module (SIM) having an algorithm and a key to support authorization and encryption necessary to enable or facilitate communication with a private cellular network.

The information processor 106 is coupled to a card holder/reader with one or more GSM-Type Cards or 3G-Type universal SIM Cards held in the card holder reader. Each SIM Card has stored therein subscriber identification and security information for one or more user profiles. There are two ways of coupling the card holder/reader to the processor 106 including a Universal Serial Bus (USB) adapter that enables the processor 106 to communicate with a 3GSM SIM Card or use of Blue Tooth.

In the preferred embodiment of the invention, the Subscriber Identification Module SIM Card 114 also includes program code to enable the information processor 106 to control supplemental services provided by the private or public network. Further, the SIM Card includes a program to enable the processor 106 to control value added services provided by public or private networks, such as email, calendar or wireless inventory. In addition, the preferred embodiment of the invention includes a wireless modem that allows a user to connect to the internet using 850, 900, 1800 and 1900 MHz frequency bands.

As illustrated in Figure xxx, the invention also contemplates a method for providing wireless access to an external service for a high speed connection to the internet. The method includes the step 150 of providing a computer including a modem for connecting the computer to the internet in step 152. This connection is made by an Internet Wireless Third Generation System Modem (IW3GSM).

What is claimed is:

1. An information processing system for providing a user with wireless access to an external service provider, said system comprising:
a computer including a computer readable memory; and
a processor capable of executing instructions from the computer program stored in the computer readable memory.
a transceiver capable of communicating with an access point of a Wireless Area Network (WAN);
an Internet Wireless Third Generation for Global Mobile Modem (IW3GSM) for connection to the internet using third Generation Global System for Mobile Communications (3GSM) General Packet Radio Services (GPRS) and/or Enhanced Data for Global Evaluation (EDGE); and
a Subscriber Identification Module (SIM) card that fits inside a phone based on GSM technology including the network activation module.

2. An information processing system for providing a user with wireless access to an external source provider according to claim 1 which includes a virtual identity module including subscriber identification and security information stored in said SIM card to enable the information processing device to communicate with a public cellular network.

3. An information processing system for providing a user with wireless to an external service provider according to claim 2 wherein said Subscriber Identity Module (SIM) includes a program code to enable the information processing system to control supplemental services provided by the public network or private network.

4. An information processing system for providing a user with wireless access to a external service provider according to claim 2 in which said Subscriber Identification Module (SIM) card includes a program code to enable the information processing system to control value added services provided by the public network or private network.

5. An information processing system for providing a user with wireless access to external service provider according to claim 4 wherein the value added services controlled by the computer program include email, calendar and wireless inventory.

6. An information processing system for providing a user with wireless access to an external service provider according to claim 5 which includes a wireless modem allowing a user to connect to the internet using 850, 900, 1800 and 1900 MHz frequency bands.

7. A method for providing wireless access to an external source for high speed connection to the internet using an Internet Wireless Third Generation for Global Mobile Modem (EW3GSM), said method including the steps of:
providing a computer including a computer readable memory and a processor for executing instructions from a computer program stored in the computer readable memory;
a transceiver for connection with an access point of a Wireless Area Network (WAN) and a Subscriber Identification Module (SIM) card that fits into a telephone;
using the Subscriber Identification Module (SIM) card for access to an access point of a Third Generation System for Mobile Modem over a cellular link provided by a cellular phone company; and
accessing the internet using the cellular link provided by the phone company.

8. A method for providing wireless access to an external source for high speed connection to the internet according to claim 7 which includes the step of:
storing the subscriber identification and security information in the Subscriber Identification Module (SIM) card to enable the computer to communicate with a public cellular network.
